(19) United States
(12) Patent Application Publication
(10) Pub. No.: US 2005/0034320 A1
(43) Pub. Date: Feb. 17, 2005

(54) Drywall measuring tape

(76) Inventor: Michael L. Connor, Rowland, NC (US)

Correspondence Address: LITMAN LAW OFFICES, LTD., P.O. BOX 15035 CRYSTAL CITY STATION, ARLINGTON, VA, 22215, US

(21) Appl. No.: 10/883,789

(22) Filed: Jul. 6, 2004

Related U.S. Application Data
(60) Provisional application No. 60/494,560, filed on Aug. 13, 2003.

(51) Int. Cl. G01B 3/10

(52) U.S. Cl. 33/760

(57) ABSTRACT

The drywall measuring tape is a tape measure extendably contained within a housing, including a laser light source, such as a laser diode, located on each side of the housing. Each laser light source projects a focused light beam perpendicular to the extended tape measure, and in a plane parallel to the housing base. Thus, when the tape measure is extended across a wall with the housing base flush against the wall, one of the laser light sources projects a reference spot onto the ceiling, while the other projects onto the floor. This allows a measurement to be taken horizontally across a wall in reference to a point on the ceiling or floor. Additionally, the drywall measuring tape includes a T-square bracket on the housing base, disposed so that the drywall measuring tape can be quickly aligned with a surface edge for measurement perpendicular to the surface edge.

### CROSS-REFERENCE TO RELATED APPLICATION

This application claims the benefit of U.S. Provisional Patent Application Ser. No. 60/494,560, filed Aug. 13, 2003.

### BACKGROUND OF THE INVENTION

1. Field of the Invention

The present invention relates to measuring tapes and, more specifically to a drywall measuring tape having a T-square bracket for aligning the drywall measuring tape along an edge of a drywall sheet, and having a pair of laser light sources projecting laser light beams perpendicularly to the extended measuring tape to facilitate taking measurements relative to a remote surface.

2. Description of the Related Art

Measuring tapes are well known and widely used in countless situations where length or distance measurements are needed quickly and accurately. In construction, measuring tapes are essential to bring an architect's vision to life from a blueprint, translating written dimensions into the correct placement and sizing of raw construction materials. Where no dimensions are known or given, such as for drywall board that is hung after a structure is framed, it becomes essential to measure a space to cut a material to size.

As drywall is hung, it may be necessary to cut each sheet to fit into a specific place on a wall or ceiling surface. It is often necessary to take a measurement horizontally across a vertical surface, such as a wall, the measurement being relative to a point on an adjoining surface, such as a floor or ceiling. On a wall that meets a sloping ceiling, such as in a room with a cathedral ceiling or in a stairwell, a horizontal measurement along the wall relative to the point on the sloping ceiling where the sloping ceiling intersects the width of a drywall sheet is frequently needed. Additionally, it is frequently desirable to take measurements perpendicular to a surface edge, a wall or wall stud, or the like.

U.S. Pat. No. 6,209,219, issued on Apr. 3, 2001 to D. Wakefield, discloses a measuring tape that utilizes a single laser light beam to illuminate a point on a remote surface to take a measurement relative to the point on the remote surface. The measuring tape additionally has bubble-type level indicators disposed on the housing to facilitate positioning the housing and the projected laser beam relative to a plumb orientation. The laser light beam is useful for taking a measurement relative to a remote surface. However, because only a single laser light source is used, the measuring tape's housing must be held in a particular orientation to cast the beam at its target. The device is configured with the laser beam cast perpendicular to the measuring tape, and normal to the plane of the housing's base. However, for drywall work and many other tasks, it is preferable that a laser beam is directed perpendicular to the measuring tape but parallel to the plane of the housing's base so that, with the base of the housing held flush against a wall, a laser beam is projected toward the ceiling. Additionally, this measuring tape device lacks a T-square or other attachment that would allow the tape measure to be quickly positioned for measurements taken in relation to a surface edge, a wall or wall stud, or the like.

U.S. Patent Publication No. 2002/0059735, published on May 23, 2002, discloses a tape measure with a laser beam. A single laser device is carried in the tape measure's housing, and is directed forward substantially parallel to the extended measuring tape. In this arrangement, while the laser device provides a laser pointer conveniently contained in the tape measure's housing, the laser beam does not function to project a mark that can be used for taking a measurement relative to a remote surface. Additionally, the tape measure lacks bubble level or other orienting features or positioning features to assist in placing the tape measure in a plumb orientation or in alignment with a surface edge, a wall or wall stud, or the like.

U.S. Pat. No. 5,075,977, issued on Dec. 31, 1991 to J. Rando, describes an automatic plumb and level tool, utilizing a laser diode to project a light beam to provide a plumb or level reference. The device, however, does not perform any measuring function. U.S. Pat. No. 5,182,863, issued on Feb. 2, 1993 to J. Rando, describes an automatic plumb and level tool, utilizing a laser diode to project a light beam to provide a plumb or level reference, with a measuring capability. The measuring capability is provided in one embodiment by an acoustic distance measuring device, and in another embodiment by a measuring tape. Neither embodiment, however, orients the measuring device and the laser light beam in a manner to facilitate taking a measurement relative to a remote surface.

U.S. Pat. No. 5,894,675, issued on Apr. 20, 1999 to J. Cericola, discloses a combination tool for use in measuring, leveling, squaring, and plumbing operations. The tool is a right angle square device that is adapted to hold a tape measure and a laser pointing device. This device, however, is not a measuring tape but instead is an accessory device in which a conventional measuring tape can be housed.

None of the above inventions and patents, taken either singly or in combination, is seen to describe the instant invention as claimed. Thus a drywall measuring tape solving the aforementioned problems is desired.

### SUMMARY OF THE INVENTION

The drywall measuring tape is a tape measuring device incorporating focused light beam sources to facilitate taking measurements relative to a remote surface, and a T-square guide for bringing the drywall measuring tape quickly into alignment with a surface edge, a wall or wall stud, or the like.

The drywall measuring tape is a generally conventional tape measure extendably contained within a housing. A laser light source is located on each side of the housing. Each laser light source projects a focused light beam perpendicular to the extended tape measure, and in a plane parallel to the housing base. Thus, when the tape measure is extended across a wall with the housing base flush against the wall, one of the laser light sources projects a reference spot onto the ceiling, while the other projects onto the floor. This allows a measurement to be taken horizontally across a wall in reference to a point on the ceiling or floor.

Additionally, the drywall measuring tape includes a T-square bracket on the housing base, disposed so that the drywall measuring tape can be quickly aligned with a surface edge, a wall or wall stud, or the like for a measurement perpendicular to the surface edge, a wall or wall stud, or the like.

The drywall measuring tape may include a digital display, incorporating an electronic sensor to read electronically readable markings disposed on the tape measure to digitally display a measured distance.

Accordingly, it is a principal object of the invention to provide a drywall measuring tape using focused light beams to project a reference point to facilitate taking a measurement relative to a remote surface.

It is another object of the invention to provide a drywall measuring tape that is helpful in taking a measurement horizontally across a vertical surface, such as a wall, the measurement being relative to an adjoining horizontal surface, such as a floor or ceiling.

It is a further object of the invention to provide a drywall measuring tape that has a T-square guide so that the drywall measuring tape can be quickly aligned with an edge.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a drywall measuring tape according to the present invention.

FIG. 2 is a perspective view of a drywall measuring tape according to the present invention, with the T-square bracket removed.

FIG. 3 is an exploded view of a drywall measuring tape according to the present invention.

Similar reference characters denote corresponding features consistently throughout the attached drawings.

### DETAILED DESCRIPTION OF THE PREFERRED EMBODIMENTS

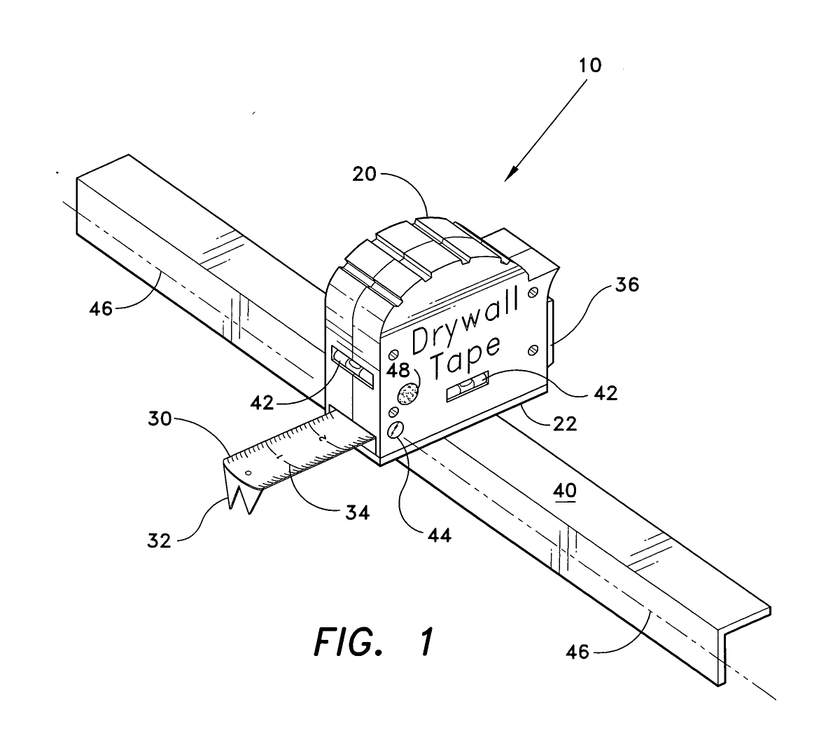

The present invention is a drywall measuring tape, designated generally as 10 in the drawings. Referring to FIGS. 1-3, the drywall measuring tape 10 comprises a housing 20 that contains a measuring tape 30. The measuring tape 30 is a conventional elongated flexible rule blade, disposed to be extended from and rewound into the housing 20 by a conventional spring reel mechanism. The housing 20 has a flat base 22. The measuring tape 30 extends from the housing adjacent to the base 22, and is extendable in line with, and in a plane roughly parallel to, the plane of the base 22.

The surface of the measuring tape 30 bears visual indicia 34 of the length of the extended tape relative to a measuring reference point of the drywall measuring tape 10. An end piece 32 is disposed on the end of the measuring tape 30. The end piece 32 functions to prevent the measuring tape 30 from being rewound into the housing 20. Additionally, the end piece 32 is useful, as with conventional measuring tapes, to hold the end of the measuring tape in place during a measurement. The end piece 32 may be pointed and sharpened so that the end piece 32 can be inserted into a wood or drywall surface to further hold the end of the measuring tape during a measurement.

The drywall measuring tape 10 includes a pair of focused light beam sources 44 mounted on the housing 20. The focused light beam sources 44 are preferably laser diodes. The focused light beam sources 44 are connected to a power supply, such as one or more replaceable or rechargeable batteries 38, and are controlled by an ON/OFF switch 48.

The focused light beam sources 44 are oriented, one on each side of the housing, to project a focused light beam 46 in a direction that is parallel to the plane of the housing base 22 and perpendicular to a line of extension of the measuring tape 30. It can be readily appreciated that, during a task such as measuring a horizontal distance across a wall with the base 22 of the housing 20 held flush against the wall, this arrangement of the focused light beam sources 44 is optimally suited for using the focused light beams 46 to align the drywall measuring tape 10 with a remote point such as point on a ceiling. Additionally, because a focused light beam source 44 is located on each side of the housing 20, the drywall measuring tape 10 is useful extended in either direction along the wall.

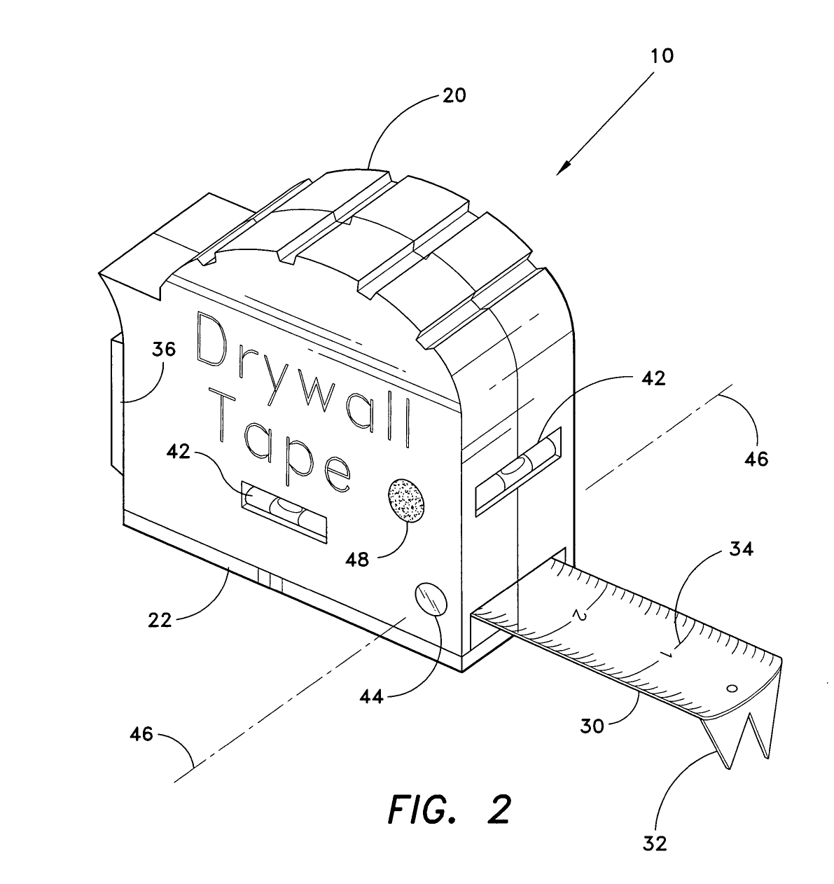

The drywall measuring tape 10 also includes a T-square bracket 40 disposed on the base 22 of the housing 20. The T-square bracket 40 is a length of aluminum or steel angle stock, which is disposed on the base 22 of the housing 20 perpendicular to the extended measuring tape 30. The T-square bracket 40 allows the drywall measuring tape 10 to be used as an extendable T-square, allowing measurements to be taken quickly in reference to a surface edge, a wall or wall stud, or the like. The T-square bracket 40 is removable, and the drywall measuring tape 10 is shown in FIG. 2 with the T-square bracket 40 removed.

The drywall measuring tape 10 also includes orientation indicators 42 disposed on the housing 20. The orientation indicators are preferably conventional bubble level indicators. The orientation indicators 42 are disposed on the sides and the front of the housing 20.

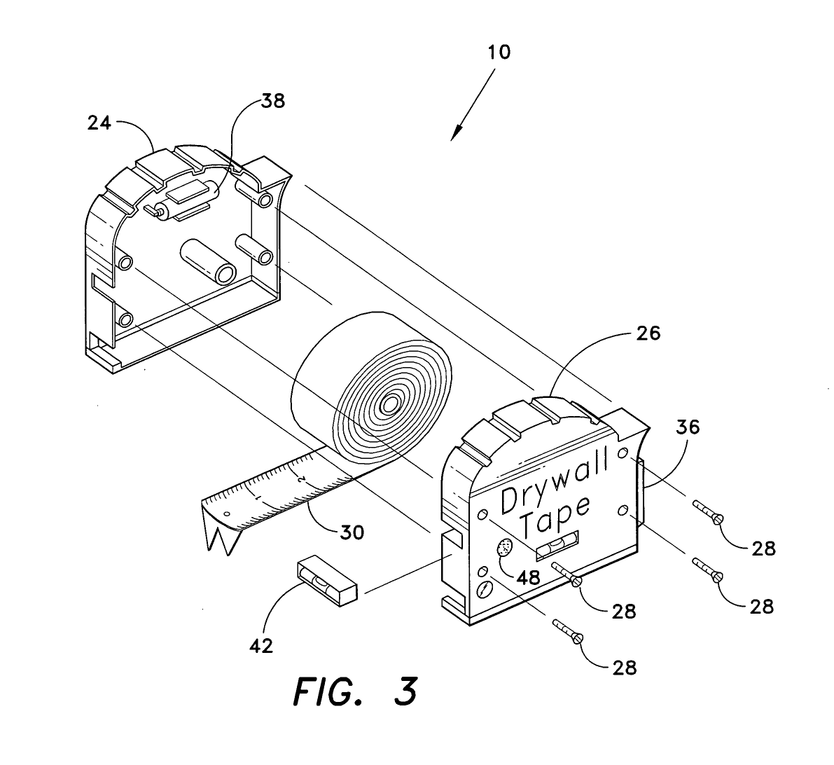

Turning now to FIG. 3, the drywall measuring tape 10 is adapted for the easy removal and replacement of the measuring tape 30. The housing 20 is formed of two cooperating halves 24, 26 that are joined together by screws 28, or in any other manner that facilitates the quick disassembly and assembly of the housing 20 for removal and replacement of a damaged measuring tape. The measuring tape 30 is removably supported within the housing 20. The housing 20 is preferably formed of a rigid rubber, plastic, or other material for durability. A blade locking actuator 36 is disposed on the housing 20 and functions to lock the measuring tape 30 in a known, conventional manner.

In the use of a conventional tape measure, a measured distance is generally determined from indicia printed on the surface of the measuring tape 30, read from the measuring tape 30 at the front of the housing. However, a distance measured by the drywall measuring tape 10 that is relative to the focused light beam sources 44 must be adjusted to account for a distance that the focused light beam sources 44 are set back from the front of the housing 20. This may be accomplished by offsetting the visual indicia 34 on the measuring tape 30 so that the distance read at the front of the housing includes the offset distance from the front of the housing to the point on the measuring tape 30 that is in vertical alignment with the focused light beam sources 44. Alternatively, the drywall measuring tape 10 may incorporate means for digitally displaying a measured distance. It is known in the art to provide electronically readable indicia on a tape measure, and to employ an electronic means to read the indicia and display a measured distance. U.S. Pat. Nos. 4,186,490, 4,747,215, and 5,628,120 illustrate and teach various means for including electronically readable indicia on a measuring tape and for electronically reading the indicia and displaying a measured distance. The '490, '215, and '120 patents are hereby incorporated by reference in their entirety.

It is to be understood that the present invention is not limited to the embodiments described above, but encompasses any and all embodiments within the scope of the following claims.

1. A drywall measuring tape, comprising:
a housing having two separate mating halves, the separate mating halves cooperating to form an interior chamber, the housing having a base, the base defining a base plane;
a measuring tape supported within said interior chamber, the measuring tape being extendable from said housing along a line of extension, the line of extension being in line with and in a plane parallel to the plane of the base;
a focused light source disposed on each of said mating halves, each focused light source projecting a focused light beam outward from said housing, each focused light beam being projected perpendicularly to the line of extension and parallel to the base plane;
a power supply disposed within said housing, the power supply being connected to said focused light source; and
a switch disposed on said housing, the switch being electrically connected between said power supply and said focused light source.

2. The drywall measuring tape according to claim 1, further comprising a T-square bracket disposed on said housing base.

3. The drywall measuring tape according to claim 2, wherein said T-square bracket comprises a length of angle stock.

4. The drywall measuring tape according to claim 2, wherein said T-square bracket is perpendicular to the line of extension.

5. The drywall measuring tape according to claim 1, further comprising a plurality of orientation indicators disposed on said housing.

6. The drywall measuring tape according to claim 5, wherein said plurality of orientation indicators comprises an orientation indicator disposed on the front of said housing.

7. The drywall measuring tape according to claim 5, wherein said plurality of orientation indicators orientation indicator disposed on each side of said housing.

8. The drywall measuring tape according to claim 1, further comprising:
electronically readable indicia disposed on said measuring tape;
reading means for reading said electronically readable indicia disposed within said housing; and
means for displaying a distance electronically read from said electronically readable indicia by said reading means.
